(19) United States
(12) Patent Application Publication
(10) Pub. No.: US 2007/0228809 A1
(43) Pub. Date: Oct. 4, 2007

(54) Full floating axle and bearing arrangement therefor

(75) Inventors: Mircea Gradu, Massillon, OH (US); Gregory C. Piotrowski, North Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: The Timken Company

(21) Appl. No.: 11/391,848

(22) Filed: Mar. 29, 2006

(51) Int. Cl. B60B 37/00

(52) U.S. Cl. 301/111.01

(57) ABSTRACT

A packaged bearing assembly for a full floating axle fits on the end of an axle tube where it serves to couple a road wheel to the axle. The bearing assembly includes a housing having external formations for mounting brake components. It also has a hub provided with a drive flange located beyond the outboard end of the housing and a spindle that projects into the housing. Finally, the bearing assembly also has an antifriction bearing located within the housing and around the spindle of the hub to enable the hub to rotate relative to the housing and axle tube. The drive flange of the hub provides a mounting for a road wheel. An axle shaft extends through the axle tube and through the hub and is removably connected to the hub, so that it can be withdrawn without elevating the road wheel off of its supporting surface.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

This invention relates in general to axles for automotive vehicles and more particularly to a full floating axle provided with a bearing assembly that enables an axle shaft to be easily removed.

Most trucks and large SUVs have solid rear axles on which the driven wheels of such vehicles rotate. Many of these vehicles, particularly large and medium trucks, utilize a full-floating axle having axle shafts that support no weight. Instead, the weight is transferred to the driven wheels through axle tubes and bearing arrangements at the ends of the tubes. In semifloating axles, the drive wheels are coupled to the axle shafts, and as a consequence, the weight of the vehicle is transferred to the wheels through both the axle tubes and the axle shafts.

Both types of axles require bearings, and the bearing systems to a measure are complex. They take an inordinate amount of time to assemble, and when repairs are required, the repairs do not proceed easily or with dispatch. For example, a full floating axle has a bearing arrangement that requires adjustment, so that the bearing operates with the proper setting, preferably slight preload. An axle shaft in a semifloating axle cannot be removed without removing the weight from the wheel at its end, and again the bearing arrangement will often interfere with the disassembly. Sometimes, one must remove a C-clip at the differential to release a shaft of a semifloating axle, and this requires opening the differential. Apart from that, the bearings of semifloating axles permit a measure of runout and lack the stability of preloaded bearings available with full floating axles.

Automotive companies in recent years have turned more and more to packaged components. These components reduce the time to assemble a vehicle, and with some components, such as wheel ends, allow critical adjustments to be made by the supplier, thus removing those adjustments from the assembly line. While outside suppliers furnish axles, the axles are in their own right overly complex and do not rely on packaging for critical components, such as bearing assemblies.

### DESCRIPTION OF THE SEVERAL VIEWS OF THE DRAWINGS

FIG. 1 is a perspective view, partially broken away and in section, of a full floating axle constructed in accordance with and embodying the present invention;

FIG. 2 is a longitudinal sectional view of the bearing assembly for the axle;

FIG. 3 is a sectional view taken along line 3-3 of FIG. 2;

FIG. 4 is a perspective view, partially broken away and in section, of a modified full floating axle; and

FIG. 5 is a longitudinal sectional view of the bearing assembly for the modified axle.

### DETAILED DESCRIPTION OF THE INVENTION

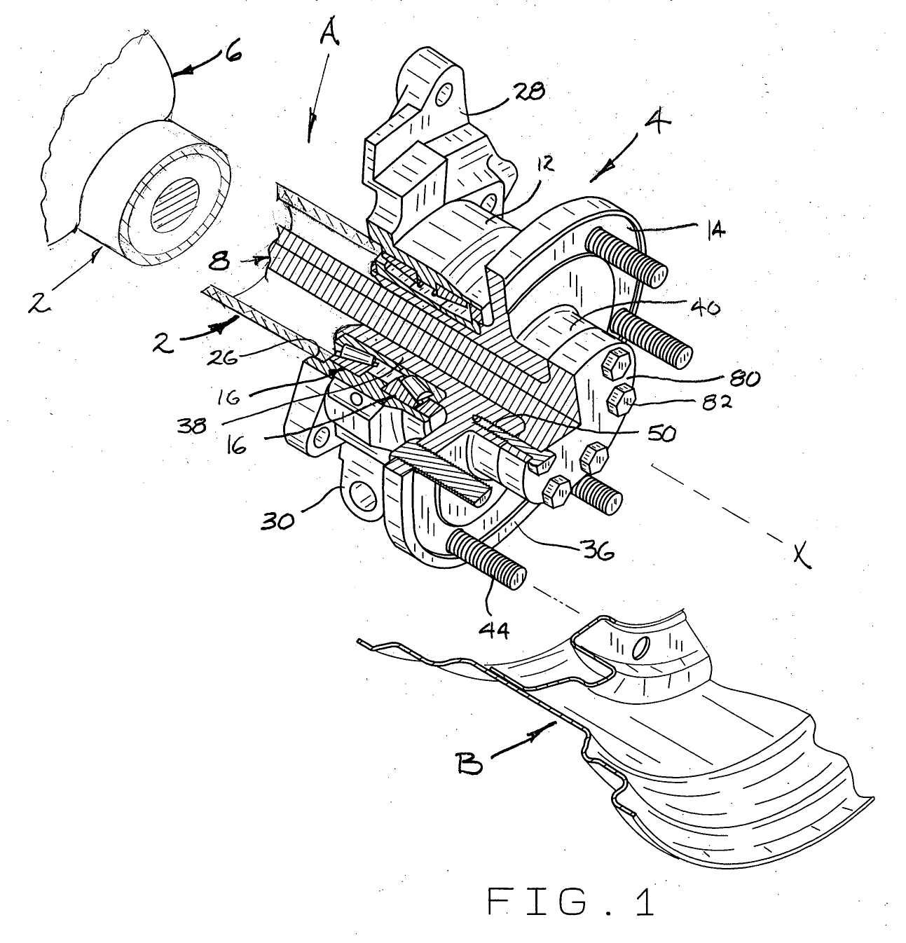

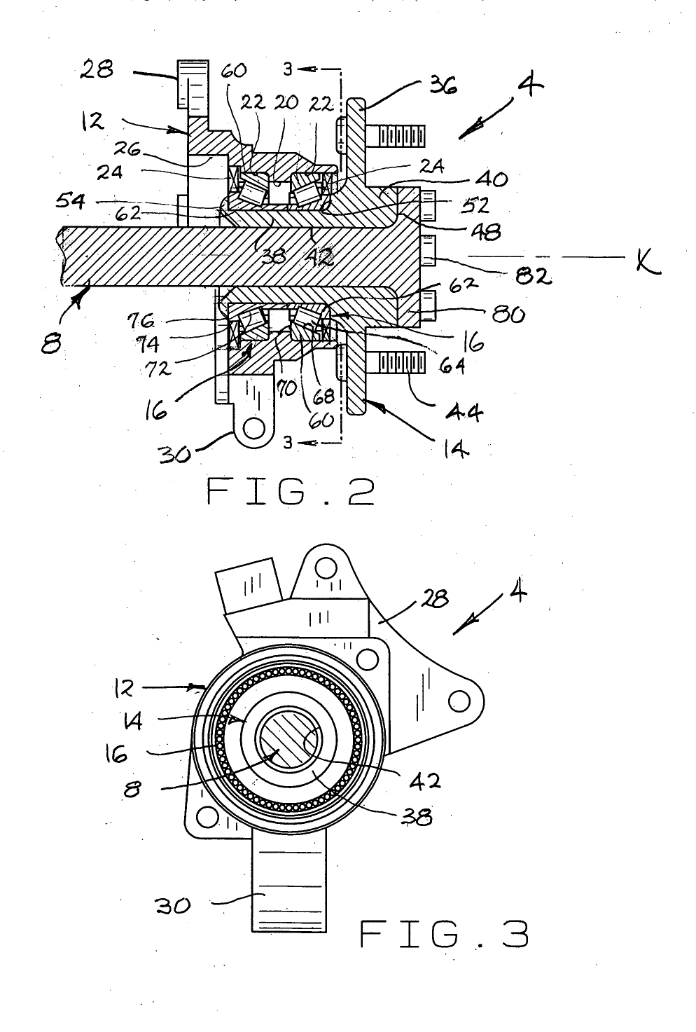

Referring now to the drawings, a solid axle A (FIG. 1) of the full floating type has the capacity to support the chassis of an automotive vehicle on wheels B and to deliver torque to those wheels B to propel the vehicle. The axle A includes an axle tube 2 that is connected to the suspension system of the vehicle. In addition, the axle A has a bearing assembly 4 that is preferably furnished as a packaged component. It is fitted to one end of the tube 2 where it couples one of the wheels B to the axle A, enabling that wheel B to rotate at the end of the axle tube 2 with minimal friction. At the opposite end of the axle tube 2 the axle A has a differential 6. Finally, the axle A has an axle shaft 8 that extends through the tube 2 from the differential 6 to the bearing assembly 4. It transfers torque to the wheel B to propel the vehicle. Actually, the axle shaft 8 transfers torque to the wheel B through the bearing assembly 4. The shaft 8 may be detached from the bearing assembly 4 and removed from the axle tube 2, all with relative ease and without removing the weight of the vehicle from the wheel B.

Considering the bearing assembly 4 first, it includes (FIGS. 2 & 3) a housing 12 that is fitted to the outboard and to the axle tube 2, a hub 14 to which the road wheel B is secured, and bearings 16 that support the hub 14 in the housing 12 and enable it to rotate relative to the housing 12 about an axis X. The axle shaft 8 is connected to the hub 14 such that it can be easily detached and withdrawn from the hub 14 and axle tube 2.

The housing 12 within its interior has a central bore 20 and at each end of the bore 20 a counterbore that serves as a bearing seat 22. Beyond each bearing seat 22, the housing 12 is fitted a seal 24. At the inboard end of the housing 12, beyond the inboard seal 24, a cylindrical socket 26 opens out of the housing 12. The socket 26 receives the outboard end of the axle tube 2, and here the tube 2 is welded or otherwise securely fastened to the housing 12. On its exterior the housing 12 has several formations for accommodating brake components. Among these formations are a flange 28 that projects generally upwardly and a boss 30 that projects downwardly. While both lie at the inboard end of the housing 12, the flange 28 is set farther inwardly toward the differential 6 than the boss 30. The flange 28 serves as a support for brake shoes, while the boss 30 houses a slave cylinder that spreads the brake shoes apart and against a brake drum.

The hub 14 includes a drive flange 36 located opposite the outboard end of the housing 12 and a spindle 38 that projects axially from the drive flange 36 into the central bore 20 of the housing 12. Projecting in the opposite direction from the drive flange 36 is a wheel pilot 40. Within its interior, the hub 14 has a through bore 42 that at one end of the hub 14 opens out of the spindle 38 and at the other end opens out of the wheel pilot 40.

The drive flange 36 has lug bolts 44 set firmly in it, and they project axially away from the outboard face of the drive flange 36. The wheel B and a brake drum fit around the wheel pilot 40, which centers them with respect to the axis X. The lug bolts 44 hold the wheel B against the drive flange 36. The wheel pilot 40 has an end face 48 that lies perpendicular to the axis X and threaded holes 50 that extend axially and open out of the end face 48.

The spindle 38 emerges from the drive flange 36 at a shoulder 52 and at its opposite end is deformed outwardly in the provision of a formed end 54. Initially, the spindle 38 at its inboard end exists as an axial extension of the remainder of the spindle 38, no greater in diameter. But once the bearings 16 are installed in the housing 12 and over the spindle 38 the axial extension is deformed outwardly in a roll-forming procedure to provide the formed end 54 that captures the bearings 16 on the hub 14. U.S. Pat. No. 6,443,622 and U.S. patent application Ser. No. 11/283,160, filed Nov. 18, 2005, disclose procedures for converting the extended end of the spindle 38 into the formed end 54 and are incorporated herein by reference.

The bearings 16 fit into the bearing seats 22 of the housing 12 and around the spindle 38 of the hub 14 where they lie captured between the shoulder 52 and the formed end 54. Each bearing 16 includes an outer race in the form of a cup 60, an inner race in the form of a cone 62, and rolling elements in the form of tapered rollers 64 located in a single row between the cup 60 and cone 62. The cup 60 has a tapered raceway 68 presented inwardly toward the axis X and a back face 70 at the small diameter end of the raceway 68. The cone 62 has a tapered raceway 72 presented outwardly toward the raceway of the cup 60 and a thrust rib 74 at the large diameter end of the raceway 72. The thrust rib 74 extends out to a back face 76. The tapered rollers 64 contact the tapered raceways 68 and 72 along their tapered side faces, there being basically line contact between the side faces and raceways 68 and 72, and the rollers 64 abut the thrust rib 74 along their large end faces. The geometry is such that the tapered rollers 64 are on apex, meaning that the conical envelopes in which their side faces lie and the conical envelopes in which the tapered raceways 68 and 74 lie have their apices at a common point along the axis X.

The cups 60 of the two bearings 16 fit into the bearing seats 22 in the housing 12 with their back faces 70 against the shoulders at the ends of those seats 22. The cones 62 fit over the spindle 38 of the hub 14, with the back face 76 of the outboard cone 62 being against the shoulder 52 on the spindle 38 and the back face 76 of the inboard cone 62 being against the formed end 54. The large ends of the tapered rollers 64 for the outboard bearing 16 are presented away from the large ends of the tapered rollers 64 of the inboard bearings 16, so that the bearings 16 are mounted in opposition in the indirect configuration. As such, the bearings 16 not only transfer radial loads between the hub 14 and housing 12, but thrust loads in both axial directions as well. Moreover, the opposite ends, that is the front faces, of the two cones 62 abut, so that the thrust exerted on the outboard cone 62 during the roll forming operation is transferred through the two cones 62 to the shoulder 52 where it is resisted. The location of front faces on the two cones 62 determines the setting for the bearings 16 and it should be one of slight preload, thus giving the hub 14 a full measure of stability.

The seals 24 have lips which bear against the thrust ribs 74 for the two cones 62 to thereby establish dynamic fluid barriers along the cones 62. Thus, the seals 24 isolate the interior of the bearings 16, retaining a lubricant, such as grease, in the bearing 16 and excluding contaminants, such as water and dirt.

The axle shaft 8 extends through the axle tube 2 and through the hub 14 rotating in the former and being coupled to the latter. At its inboard end, the axle shaft 8 is connected through a spline to gearing within the differential 6, so that the differential 6 may transfer torque to the shaft 8, yet the shaft 8 may be withdrawn from the differential 6. At the hub 14, the axle shaft 8 passes completely through the through bore 42, beyond which it has a flange 80 that overlies the end face 48 of the wheel pilot 40 on the hub 14, its diameter being no greater than that of the wheel pilot 40. The axle shaft 8 is secured to the hub 14 with cap screws 82 that pass through the shaft flange 80 and thread into the threaded holes 50 in the wheel pilot 40.

The chassis of a vehicle rests on the axle A, and the axle A in turn is supported on the wheel B with the weight of the vehicle chassis being transferred through the bearing assembly 4. The axle A, being a full floating axle, transfers none of the chassis weight through the axle shaft 8. In operation, the differential 6 transfers torque to the axle shaft 8 which in turn transfers it to the hub 14 of the bearing assembly 4. Assuming that the torque is sufficient, the hub 14 will rotate and with it the wheel B, and of course the rotating wheel B propels the vehicle. The two bearings 16 transfer radial loads—in essence the weight of the vehicle chassis—from the housing 12 to the hub 14 and any thrust loads as well—indeed, thrust loads in both axial directions.

One may withdraw the axle shaft 8 for repair or replacement, simply by removing the cap screws 82 from their threaded holds 50 in the pilot 40 of the hub 14 and pulling the shaft 8 out of the through bore 42 in the hub 14 and from the axle tube 2. And no need exists to remove the weight of the vehicle chassis from the axle tube A. The wheel B remains on the road surface supporting the vehicle as the axle shaft 8 is removed.

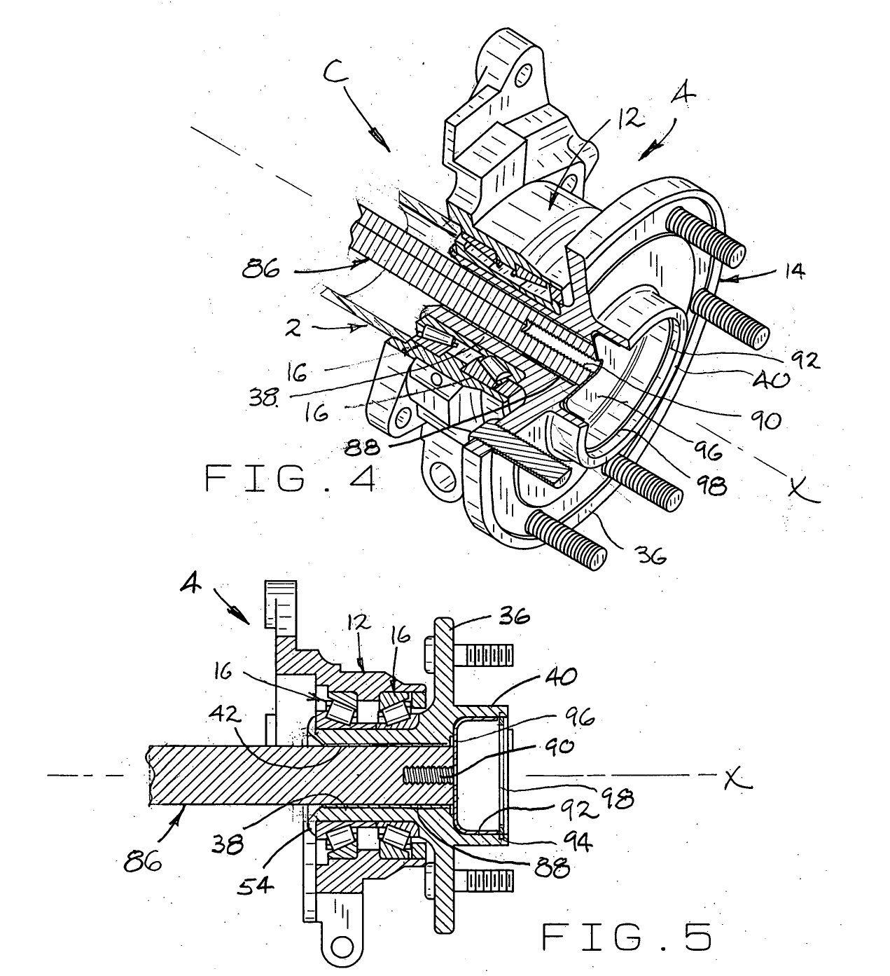

A modified bearing axle C (FIGS. 4 & 5) differs from the axle A in that it has an axle shaft 86 that is coupled to the hub 14 of the bearing assembly 4 through mating splines 88—one at the end of the through bore 42 in the hub 14 and the other at the outboard end of the shaft 86. To this end, the spline 88 on the end of the shaft 86 possesses a diameter slightly greater than the diameter of the remainder of the shaft 86 so as to prevent the spline 88 in the hub 14 from interfering with the removal of the shaft 86. In addition, the axle shaft 86 has a threaded hole 90 at its outboard end, so that the shaft 86 may be engaged by a tool and pulled from the hub 14 and axle tube 2.

Apart from that, the wheel pilot 40 of the hub 14, in lieu of having threaded holes 50, has a socket 92 that opens axially out of its end and a groove 94 that opens radially into the socket 92. The socket 92 receives a stamped metal plug 96, while the groove 94 receives a spring clip 98. The plug 96 prevents the axle shaft 86 from migrating out of the hub 14, whereas the spring clip 98 retains the plug 96 in the socket 92.

To withdraw the axle shaft 86, one removes the spring clip 98, thereby releasing the plug 96 which is withdrawn form the socket 90. Then the axle shaft 86 is engaged with a tool that threads into the threaded hole 90 in the end of the shaft 86, and through the tool a withdrawal force is applied to the shaft 86.

Variations are possible. For example, the outer raceways 68 for the bearings 16 may be machined directly into the housing 12. Likewise, the outboard inner raceway 72 and thrust rib 74 may be machined directly into the spindle 38 of the hub 14, leaving only the inboard inner cone 62 as an initially separate race to be installed over the hub spindle 38. Moreover, the outer raceways 68 may be on a single double cup retained in the housing 12 by snap rings or other devices. For that matter, other types of bearings having inclined raceways, such as angular contact ball bearings or spherical roller bearings, may be substituted for the tapered roller bearings 16. Indeed, deep groove ball bearings or even a single row cylindrical roller bearing may be substituted for the tapered roller bearings 16. The housing 12 may have formations that accommodate components of a disk brake in lieu of a drum brake.

1. A full floating axle for an automotive vehicle, said axle comprising:
an axle tube having inboard and outboard ends;
a bearing assembly at the outboard end of the axle tube, and including a housing secured firmly to the axle tube, a hub having a drive flange located beyond the housing and a spindle that projects into the housing, and an antifriction bearing located between the housing and hub spindle to enable the hub to rotate relative to the housing about an axis; and
an axle shaft extended through the axle tube and into the hub, the shaft being coupled to the hub such that the hub and shaft rotate together, the shaft being separable from the hub and removable axially from the axle tube and the hub.

2. An axle according to claim 1 wherein the axle shaft is removably attached to the hub with screws.

3. An axle according to claim 2 wherein the axle shaft at its outboard end has a flange that extends over the end of the hub, and the screws pass through the shaft flange and into the hub.

4. An axle according to claim 3 wherein the hub has a wheel pilot that projects beyond the drive flange; wherein the shaft flange extends over the end of the wheel pilot; and wherein the screws extend into the wheel pilot.

5. An axle according to claim 1 wherein the hub has a through bore that extends through the hub spindle, and the axle shaft is in the through bore; and wherein the axle shaft and hub have mating splines so that the axle shaft and hub rotate together, the diameter of the spline on the shaft being greater then the diameter of the remainder of the shaft to enable the shaft to be withdrawn through the hub.

6. An axle according to claim 5 wherein the hub has a socket into which the through bore opens, and the socket opens out of the end of the hub; and wherein a plug occupies the socket to prevent the axle shaft from migrating out of the hub.

7. An axle according to claim 6 wherein the hub at its outboard end has a wheel pilot that projects axially beyond the drive flange, and the socket is in the wheel pilot.

8. An axle according to claim 6 wherein the axle shaft has a threaded hole at its outboard end to enable a tool to engage the shaft and withdraw it from the hub.

9. An axle according to claim 1 wherein the bearing includes outboard and inboard raceways carried by the housing and inclined in opposite directions with respect to the axis; outboard and inboard raceways carried by the spindle of the hub, the outboard raceway on the spindle being presented toward the outboard raceway on the housing and inclined in the same direction, the inboard raceway on the spindle being presented toward the inboard raceway on the housing and inclined in the same direction; and outboard rolling elements arranged in a row between the outboard raceways and inboard rolling elements arranged in a row between the inboard raceways.

10. An axle according to claim 9 wherein the outboard and inboard raceways taper downwardly toward each other, and the rolling elements are tapered rollers.

11. A bearing assembly for a full floating axle, said bearing assembly comprising:
a housing having a hollow interior and external formations for accommodating brake components, the housing further being configured to accommodate an axle tube;
a hub having a drive flange located beyond the housing and a spindle that projects into the hollow interior of the housing, the hub having within its spindle a through bore that extends from one end of the hub to the other end, with the through bore being configured to receive an axle shaft;
a bearing located within the housing between the hub spindle and the housing for enabling the hub to rotate relative to the housing about an axis; and
means for coupling an axle shaft to the hub so that the shaft and hub rotate together.

12. A bearing assembly according to claim 11 wherein the means for coupling an axle shaft include threaded holes that are directed axially and open out of the hub away from the housing.

13. A bearing assembly according to claim 12 wherein the means for coupling the axle shaft includes a spline in the through bore.

14. A bearing assembly according to claim 13 wherein the means for coupling an axle shaft includes a socket that opens out of the hub away from the housing and into which the through bore opens and a plug in the socket to prevent an axle shaft from migrating out of the through bore.

15. The bearing assembly according to claim 11 in combination with an axle shaft that extends through the through bore of the hub and is retained in the hub by the means for coupling an axle shaft.

16. The combination according to claim 15 wherein the axle shaft has a flange at its end, and the means for coupling the axle shaft to the hub includes screws that pass through the flange on the axle shaft and thread into the hub around the through bore.

17. The combination according to claim 15 wherein the means for coupling the axle shaft includes mating splines on the axle shaft and along the through bore of the hub; and wherein the diameter of the spline on the axle shaft is greater than the diameter of the remainder of the shaft.

18. The combination according to claim 17 wherein the hub has a socket that opens away from the housing and the through bore opens into the socket; and further comprising a plug in the socket to prevent the axle shaft from migrating out of the through bore.

19. The combination according to claim 17 wherein the shaft has a threaded hole at its end to enable a tool to engage the axle shaft and exert a withdrawal force on it.

20. The combination according to claim 15 and further comprising an axle tube attached to the housing and axially aligned with the spindle of the hub; and wherein the axle shaft extends through the axle tube.
